(19) United States
(12) Patent Application Publication
(10) Pub. No.: US 2009/0223931 A1
(43) Pub. Date: Sep. 10, 2009

(54) DRY ETCHING METHOD AND APPARATUS

(76) Inventor: Shuji TAKAHASHI, Kanagawa-ken (JP)

Correspondence Address: BIRCH STEWART KOLASCH & BIRCH, PO BOX 747, FALLS CHURCH, VA, 22040-0747, US

(21) Appl. No.: 12/396,911

(22) Filed: Mar. 3, 2009

(30) Foreign Application Priority Data
Mar. 4, 2008 (JP) 2008-053532

(51) Int. Cl. B44C 1/22; C23F 1/08

(52) U.S. Cl. 216/67; 156/345.48

(57) ABSTRACT

The dry etching method of performing etching, includes the steps of: supplying a processing gas which is a gas mixture of a plurality of fluorochemical gases; and generating plasma under a high vacuum while supplying the processing gas and applying a low-frequency bias voltage.

### BACKGROUND OF THE INVENTION

1. Field of the Invention

The present invention relates to a dry etching method and a dry etching apparatus, and more particularly to a dry etching method and a dry etching apparatus using a gas mixture of a plurality of fluorochemical gases as a processing gas.

2. Description of the Related Art

In general, when using dry etching to process material that is not readily etchable, such as ferroelectric substances used in piezoelectric elements and ferroelectric memory (FeRAM) and precious metals used as electrodes in these elements, it is common to use as the processing gas a gas mixture of an inert gas (e.g., argon) and a gas containing a halogen (e.g., fluorine or chlorine).

Japanese Patent Application Publication No. 2006-294846 discloses a dry etching method for a ferroelectric body used in a piezoelectric element, or the like, in which a gas mixture of an inert gas and a fluorocarbon gas is used as the etching processing gas, and a high-frequency bias voltage is applied to the etching objective body (ferroelectric body) under a high vacuum and in the presence of high-density plasma. According to this method, deposit (adhering matter) is not liable to adhere to the lateral faces of the etching objective body.

However, in the dry etching that uses the gas mixture of the inert gas and the fluorocarbon gas, there is a problem in that there is low selectivity with respect to the etching objective body and the resist that is used as the etching mask. If the resist selectivity is low, then it is necessary to make the resist forming the mask thicker; however, if the resist is made thicker, then the resolution declines and high precision processing cannot be achieved. Furthermore, if the etching rate is raised (speeded up), then it is not possible to ensure the selectivity with respect to the resist, and it is difficult to accelerate the etching rate.

On the other hand, in dry etching that uses an inert gas only, there is a problem in that a large amount of reaction product (hereinafter also referred to as “lateral face adhering matter” or “lateral face deposit film”) adheres on the lateral faces of the etching objective body. Moreover, even in cases where the gas mixture of the inert gas and the fluorocarbon gas is used, if the sputter etching by the inert gas is strong, then lateral face adhering matter (lateral face deposit film) occurs and the margins of the etching conditions are narrowed.

Furthermore, it is also possible to adopt a method that uses a gas mixture of a gas containing chlorine and a gas containing fluorine; however, many gases containing chlorine are toxic or poisonous and in order to ensure safety, it is necessary to provide additional equipment such as special gas piping and emergency exhaust equipment, which leads to an increase in costs.

### SUMMARY OF THE INVENTION

The present invention has been contrived in view of these circumstances, an object thereof being to provide a dry etching method and dry etching apparatus whereby the etching rate can be speeded up and the resist selectivity can be improved.

In order to attain the aforementioned object, the present invention is directed to a dry etching method of performing etching, the method comprising the steps of: supplying a processing gas which is a gas mixture of a plurality of fluorochemical gases; and generating plasma under a high vacuum while supplying the processing gas and applying a low-frequency bias voltage.

According to this aspect of the present invention, by applying the low-frequency bias voltage, even though an inert gas (e.g., argon gas) is not used as the processing gas, the ion energy is high and satisfactory etching performance can be achieved. Furthermore, by using the mixture of the plurality of fluorochemical gases, it is possible to speed up the etching rate and to improve the resist selectivity.

In the present invention, a particularly desirable mode is one where the etching objective body is a piezoelectric body (piezoelectric film). In this case, the beneficial effects of the present invention described above can be displayed more remarkably.

Preferably, the gas mixture is of SF₆ gas and a gas containing fluorine. In the present invention, a desirable mode is one where the gas mixture of SF₆ (sulfur hexafluoride) gas and a gas containing fluorine is used as the processing gas. As the gas containing fluorine, it is possible to use any of gases such as C₄F₈ (octafluorocyclobutane), C₂F₆ (hexafluoroethane), C₃F₆ (hexafluoropropylene), C₃F₈ (octafluoropropane), C₄F₆ (hexafluoro-1,3-butadiene), C₅F₈ (octafluorocyclopentene), CF₄ (tetrafluoromethane), and the like. By using SF₆ gas, it is possible to speed up the etching rate.

Preferably, a mixture ratio of SF₆ gas is not higher than 40%. In the present invention, a desirable mode is one where the mixture ratio of SF₆ gas is not higher than 40% (and more desirably not higher than 30%, and yet more desirably, 20%), since this makes it possible to achieve high resist selectively as well as obtaining a satisfactory etching rate.

Preferably, the gas containing fluorine is C₄F₈. In the present invention, a desirable mode is one which uses C₄F₈ gas as the gas containing fluorine. C₄F₈ gas has an action of forming a protective film on the resist, and therefore it is possible to raise the resist selectivity.

Preferably, a frequency of the bias voltage is not lower than 200 kHz and not higher than 2 MHz. In the present invention, the frequency of the bias voltage is desirably not lower than 200 kHz and not higher than 2 MHz (and more desirably not lower than 400 kHz and not higher than 600 kHz). This raises the ion energy and makes it possible to obtain satisfactory etching performance.

In order to attain the aforementioned object, the present invention is also directed to a dry etching apparatus, comprising: a vacuum container containing a stage on which a body to be etched is mounted; a high-frequency power source which generates plasma in the vacuum container; a processing gas supply device which supplies a processing gas into the vacuum container; and a bias power source which applies a low-frequency bias voltage to the stage, wherein the processing gas is a gas mixture of a plurality of fluorochemical gases.

According to the present invention, by applying a low-frequency bias voltage, even though an inert gas (e.g., argon gas) is not used as the processing gas, the ion energy is high and satisfactory etching performance can be achieved. Furthermore, by using a mixture of a plurality of fluorochemical gases, it is possible to speed up the etching rate and to improve the resist selectivity.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a cross-sectional diagram showing the general composition of a dry etching apparatus according to an embodiment of the present invention;

FIGS. 2A to 2J are illustrative diagrams showing steps of manufacturing a piezoelectric element;

FIG. 3 is a graph showing the relationship between the mixture ratio of SF₆ gas, and the etching rate and the resist selectivity, in a case where a gas mixture of SF₆ gas and C₄F₈ gas is used; and

FIG. 4 is a normalized graph in which the etching rate and resist selectivity in FIG. 3 are multiplied together.

### DETAILED DESCRIPTION OF THE PREFERRED EMBODIMENTS

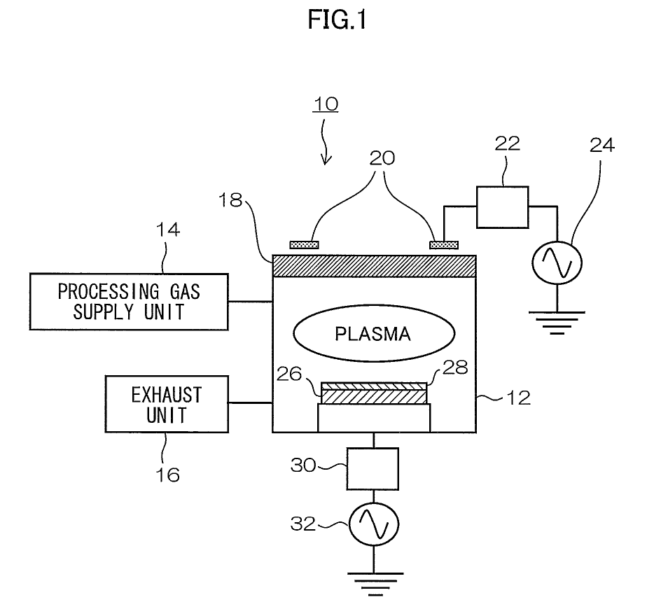

FIG. 1 is a cross-sectional view showing the general composition of a dry etching apparatus according to an embodiment of the present invention. The dry etching apparatus 10 shown in FIG. 1 includes: a vacuum chamber 12; a processing gas supply unit 14, which supplies processing gas (etching gas) to the chamber 12, an exhaust unit 16, which expels the gas from the chamber 12; and a pressure adjustment unit (not shown), which adjusts the pressure inside the chamber 12. The pressure inside the chamber 12 is adjusted by supplying the processing gas through the processing gas supply unit 14 to the chamber 12, while expelling the gas through the exhaust unit 16. As described hereinafter, a gas mixture of a plurality of fluorochemical gases is used as the processing gas in the present embodiment.

A dielectric window 18 is hermetically arranged on the upper surface of the chamber 12, and a loop antenna 20 is arranged on the upper side (the atmosphere side) of the dielectric window 18. A high-frequency power source 24 for generating plasma is connected to the antenna 20 through a matching circuit (matching box) 22. The frequency of the high-frequency power source 24 is not lower than 13.56 MHz and not higher than 60 MHz; and, for example, a frequency of 13.56 MHz is used. The high-frequency power source 24 may also be pulse-driven.

A substrate cooling mechanism (not shown) equipped with an electrostatic chuck or clamp is arranged on a stage 26 in the chamber 12, and a substrate 28 to be etched is mounted on the stage 26. A low-frequency power source 32 for applying a bias voltage is connected to the stage 26 through a matching circuit 30. The frequency of the low-frequency power source 32 is not lower than 200 kHz and not higher than 2 MHz, preferably not lower than 400 kHz and not higher than 600 kHz; and, for example, a frequency of 600 kHz is used. The low-frequency power source 32 may also be pulse-driven, similarly to the high-frequency power source 24. Moreover, if the high-frequency power source 24 and the low-frequency power source 32 are both pulse-driven, then it is desirable to provide a device that synchronizes the pulses of the power sources.

The dry etching apparatus 10 according to the present embodiment employs an Inductive Coupled Plasma (ICP) as shown in FIG. 1; however, the implementation of the present invention is not limited in particular to this embodiment, and it is also possible to employ a system that uses a plasma source such as, for instance, a Helicon Wave Plasma (HWP), an Electron Cyclotron resonance Plasma (ECP), a microwave-excited Surface Wave Plasma (SWP), or the like.

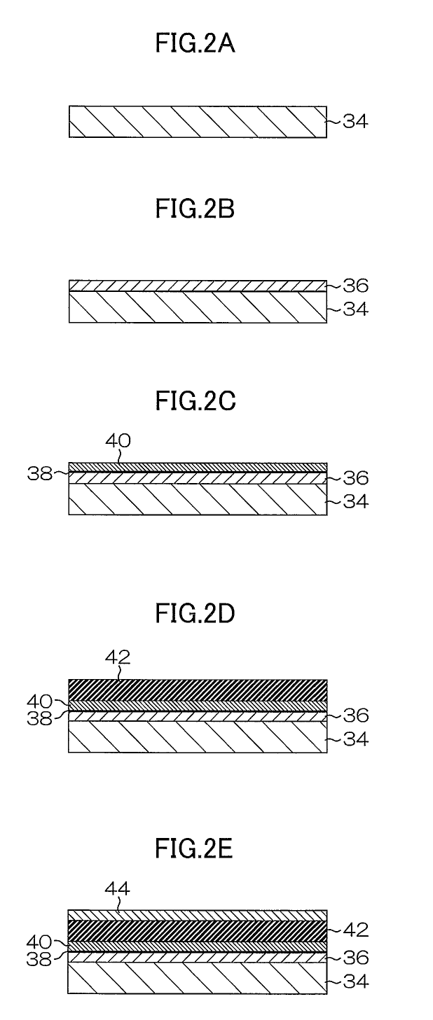

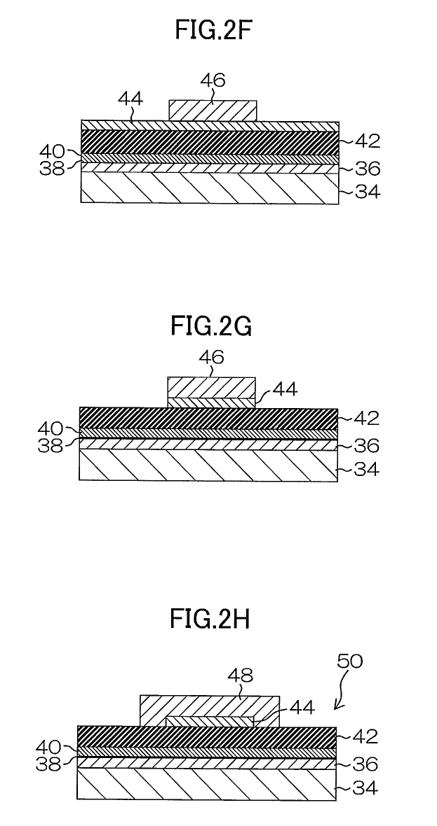

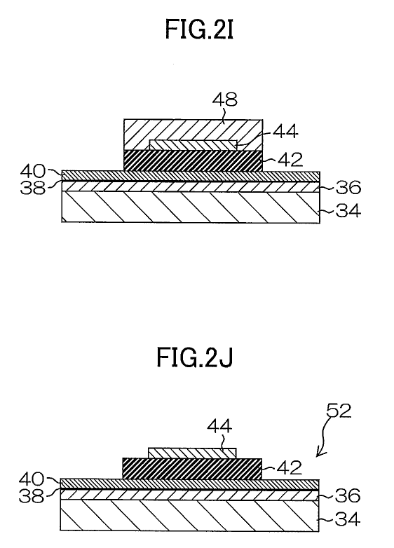

Next, the dry etching method is described. FIGS. 2A to 2J are illustrative diagrams showing steps for manufacturing a piezoelectric element. Firstly, a silicon (Si) substrate 34 shown in FIG. 2A is prepared, and an insulating film 36 is formed on the substrate 34 as shown in FIG. 2B. Thereupon, an adhesive layer 38 is formed on the insulating film 36 and a lower electrode film (made of precious metal) 40 is formed on the adhesive layer 38 as shown in FIG. 2C. Next, a piezoelectric film (made of ferroelectric material) 42 is formed on the lower electrode film 40 as shown in FIG. 2D, and an upper electrode film (made of precious metal) 44 is formed on the piezoelectric film 42 as shown in FIG. 2E. For example, the insulating film 36 is an oxide (SiO₂) film, which can be formed by sputtering, Chemical Vapor Deposition (CVD), or thermal oxidation. The adhesive layer 38 can be made of a titanium (Ti) layer, which can be formed by sputtering. Moreover, the lower electrode film 40 and the upper electrode film 44 are films of a precious metal, such as platinum, iridium, ruthenium, or oxides of same, which can be formed by sputtering, CVD, or the like. Furthermore, the piezoelectric film 42 can be a PZT (lead zirconate titanate) film, which can be formed by sputtering, CVD, or the like.

Next, resist 46 is formed (applied) on the upper electrode film 44, and processes of pre-baking (soft baking), exposure, development and post-baking are carried out in sequence, and the resist 46 is patterned into a prescribed shape as shown in FIG. 2F. Thereupon, the upper electrode film 44 is patterned by dry etching, using the patterned resist 46 as a mask as shown in FIG. 2G.

Next, a mask layer 48 is formed over the piezoelectric film 42 as shown in FIG. 2H. It is possible to use resist or an oxide film as the mask layer 48, and it is also possible to use a hard mask made of metal, or the like. Of these options, a desirable mode is one which uses resist as the mask layer 48. In this case, resist is formed on the piezoelectric film 42 by spin coating, or the like, and processes of pre-baking (soft baking), exposure, development and post-baking are carried out in sequence, and the resist is patterned into a prescribed shape. In this case, instead of post-baking, it is also possible to carry out UV (ultraviolet) curing.

If a hard mask is used as the mask layer 48, then a photolithography step and an etching step for depositing and patterning the hard mask are required. On the other hand, if a resist mask is used, then the patterning of the hard mask becomes unnecessary and the number of steps required to manufacture the mask are reduced and costs can be lowered. Consequently, from the viewpoint of reducing costs, a desirable mode is one which uses the resist.

Next, dry etching of the piezoelectric film 42 is carried out as shown in FIG. 2I. More specifically, the substrate to be etched (denoted with reference numeral 50) on which the piezoelectric film 42 has been formed is placed on the stage 26 in the chamber 12 of the dry etching apparatus 10 shown in FIG. 1. Thereupon, the interior of the chamber 12 is set to a vacuum state, and a gas mixture of SF₆ gas and a gas compound containing fluorine (e.g., C₄F₈) is supplied as a processing gas through the processing gas supply unit 14, and is expelled through the exhaust unit 16 so that the internal pressure of the chamber 12 is regulated to a prescribed pressure (for example, 0.7 Pa). Thereupon, a high-frequency voltage of 13.56 MHz is applied at a power of 400 W to the antenna 20 by the high-frequency power source 24 for generating plasma, and an electromagnetic wave is radiated into the chamber 12 from the antenna 20 through the dielectric window 18, thereby generating high-density plasma inside the chamber 12. During this, a low-frequency voltage of 600 kHz is applied at a power of 150 W to the stage 26 by the low-frequency power source 32 for applying the bias voltage. In the present embodiment, the frequency of the voltage applied by the low-frequency power supply 32 is set to 600 kHz; however, it can also be set to a frequency not lower than 200 kHz and not higher than 2 MHz, and preferably not lower than 400 kHz and not higher than 600 kHz. Thus, the piezoelectric film 42 is etched in the portion that is not covered with the mask layer 48, and the piezoelectric film 42 is thereby patterned into the shape corresponding to the mask layer 48. Thereupon, by removing the mask layer 48, a piezoelectric element 52 having the lower electrode film 40, the piezoelectric film 42 and the upper electrode 44 can be formed on the silicon substrate 34 as shown in FIG. 2J.

The following Table 1 shows the relationship between the etching rate (etching speed), resist selectivity, occurrence of lateral face deposit film (lateral face adhering matter), resist detachability, and apparatus cost, in respect of different types of processing gas (etching gas).

TABLE 1

| | Processing | | Etching rate | Resist | Lateral face | Detachability | Apparatus |
|---|---|---|---|---|---|---|---|
| | gas | | (nm/min) | selectivity | deposit film | of resist | cost |
| Comparative | CF₄ | Ar | 60 | 0.35 | None | Easy | Low |
| Example 1 | | | | | | | |
| Comparative | SF₆ | Ar | 106 | 0.22 | None | Easy | Low |
| Example 2 | | | | | | | |
| Comparative | CF₄ | | 112 | 0.35 | Present | Difficult | Low |
| Example 3 | | | | | (small amount) | | |
| Comparative | SF₆ | | 200 | 0.29 | Present | Difficult | Low |
| Example 4 | | | | | (large amount) | | |
| Comparative | Cl₂ | C₄F₈ | 126 | 0.66 | None | Complicated | High |
| Example 5 | | | | | | | |
| Example of | SF₆ | C₄F₈ | 148 | 0.7 | None | Easy | Low |
| the Invention | | | | | | | |

In Example of the Invention and Comparative Examples 1 to 5, apart from the difference in the type of processing gas, processing was carried out under the same conditions as follows: the pressure inside the chamber 12 was set to 0.7 Pa, the frequency and power of the high-frequency power source 20 for the antenna were set to 13.56 MHz and 400 W, and the frequency and power of the low-frequency power source 32 for applying the bias voltage were set to 600 kHz and 150 W.

As shown in Table 1, Comparative Example 1 is a case where a gas mixture of a fluorocarbon gas as the fluorochemical gas and an inert gas is used, and more particularly, a gas mixture of CF₄ gas and Ar gas of which the mixture ratio (flow rate ratio) was 8:2 was used. In Comparative Example 1, the etching rate was the slowest of the examples compared here, and the resist selectivity was one half of that of the Example of the Invention. There was no occurrence of lateral face deposit film.

Comparative Example 2 is a case where SF₆ gas is used as the fluorochemical gas instead of the fluorocarbon gas of Comparative Example 1, and the mixture ratio (flow rate ratio) was 8:2, similarly to Comparative Example 1. In Comparative Example 2, the etching rate was faster than in Comparative Example 1, but slower than in the Example of the Invention. Furthermore, the resist selectivity was lower than the Comparative Example 1. There was no occurrence of lateral face deposit film.

Comparative Example 3 is a case where only a fluorocarbon gas is used as the fluorochemical gas and no inert gas is used, and more particularly, only CF₄ gas was used. In Comparative Example 3, the etching rate was faster than in Comparative Example 1, but a small amount of lateral face deposit film occurred. The resist selectivity was the same as Comparative Example 1.

Comparative Example 4 is a case where SF₆ gas is used as the fluorochemical gas instead of the fluorocarbon gas of Comparative Example 3. In Comparative Example 4, the etching rate was the fastest of the examples compared here. However, the resist selectivity was lower than Comparative Example 3, and was lower than one half of the Example of the Invention. Moreover, a large amount of lateral face deposit film occurred.

Accordingly, it can be seen that, compared to the cases where CF₄ gas is used as the fluorochemical gas (Comparative Examples 1 and 3), using SF₆ gas as the fluorochemical gas (Comparative Examples 2 and 4) is effective in accelerating the etching rate. However, it can be seen that in each of these cases, the resist selectivity is lower than a half of the resist selectivity in the Example of the Invention, and hence is not suitable for achieving high accuracy of the resist. Furthermore, it can also be seen that if only the fluorochemical gas is used without using inert gas (Comparative Examples 3 and 4), a lateral face deposit film is liable to occur.

Comparative Example 5 is a case where a gas mixture of a gas containing chlorine and a gas containing fluorine is used, and more particularly, a gas mixture of Cl₂ gas and C₄F₈ gas of which the mixture ratio (flow rate ratio) was 8:2 was used. In Comparative Example 5, the etching rate was slower than the Example of the Invention, but faster than in Comparative Examples 1 to 3. Furthermore, the resist selectivity is slightly smaller than the Example of the Invention, but is greater than in Comparative Examples 1 to 4. There was no occurrence of lateral face deposit film. In this way, in Comparative Example 5, it is possible to achieve results which are good overall in terms of the etching rate, the resist selectivity, and the occurrence of lateral face deposit film in comparison with Comparative Examples 1 to 4.

However, in cases where the gas mixture of the gas containing chlorine and the gas containing fluorine are is used, compounds containing F, Cl, Pb, Zr and Ti are formed as reaction products when the piezoelectric film is etched. These reaction products are complex and there is a problem in that it becomes difficult to detach the resist. Moreover, gases containing chlorine are toxic or poisonous and therefore dangerous, and additional equipment such as special gas piping and emergency exhaust equipment is necessary, giving rise to increased costs.

On the other hand, the Example of the Invention is a case where a gas mixture of a plurality of fluorochemical gases is used, and more particularly, a gas mixture of SF₆ gas and C₄F₈ gas of which the mixture ratio (flow rate ratio) was 8:2 was used. As shown in Table 1, the etching rate and the resist selectivity in the Example of the Invention were almost better than in Comparative Examples 1 to 5, and there was no occurrence of lateral face deposit film. Moreover, the reaction product that occurs when etching the piezoelectric film is fluorochemical (fluoropolymer), and therefore it can be removed easily by using a special polymer removal solution. Further, by using a gas mixture of fluorochemical gases, it is possible to achieve etching performance which is equivalent to or superior to that achieved when using a gas mixture that includes a gas compound containing chlorine (Comparative Example 5). Furthermore, since no gas containing chlorine is used, then it is possible to reduce the costs of the apparatus and the additional equipment.

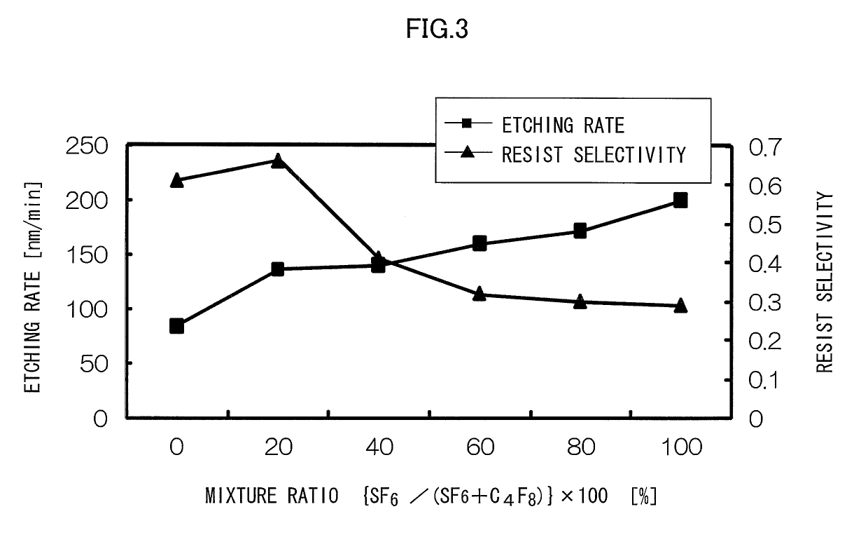

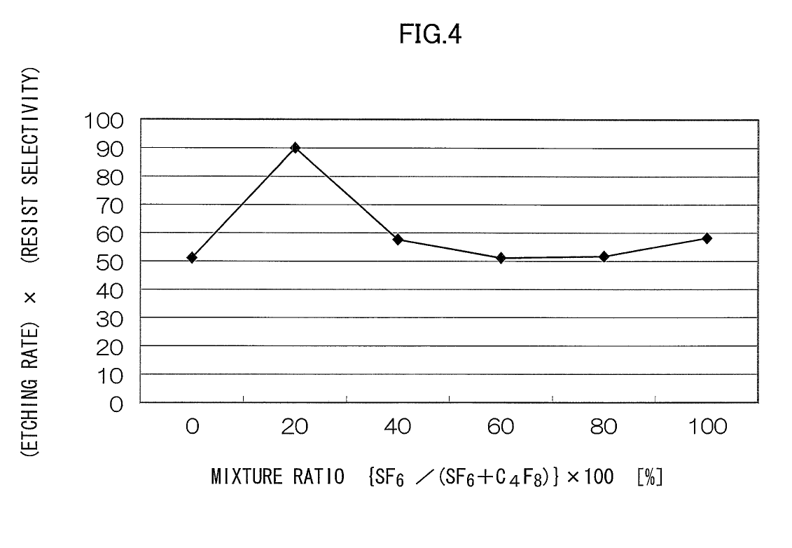

FIG. 3 shows the relationship between the mixture ratio (flow rate ratio) of SF₆ gas, and the etching rate and the resist selectivity, in a case where a gas mixture of SF₆ gas and C₄F₈ gas was used. In FIG. 3, the horizontal axis indicates the mixture ratio (flow rate ratio) of SF₆ gas in the gas mixture of SF₆ gas and C₄F₈ gas, the left-hand side vertical axis indicates the etching rate, and the right-hand vertical axis indicates the resist selectivity. Furthermore, FIG. 4 shows a normalized graph in which the etching rate and the resist selectivity shown in FIG. 3 are multiplied together.

As shown in FIG. 3, when the mixture ratio of SF₆ gas was lower than 30%, the resist selectivity was greater than 0.5, and hence good results were obtained. Furthermore, when the mixture ratio of SF₆ gas was increased, the etching rate rose, but the resist selectivity tended to decline.

As shown in FIG. 4, the product of the etching rate and the resist selectivity was a maximum value when the mixture ratio of SF₆ gas was 20%. On the other hand, when the mixture ratio of SF₆ gas exceeded 40%, substantially the same results were obtained as when the mixture ratio of SF₆ gas was 0% (i.e., when only C₄F₈ gas was used).

Consequently, by making the mixture ratio of SF₆ gas not higher than 40% (and desirably not higher than 30%, and more desirably 20%), it is possible to achieve high resist selectively as well as obtaining a satisfactory etching rate.

As described above, in the dry etching method according to the present invention, plasma is generated in a high vacuum while supplying a processing gas that is a gas mixture of a plurality of fluorochemical gases (gases that contain fluorine atoms), and etching is carried out by applying a bias voltage having a low frequency (not lower than 200 kHz and not higher than 2 MHz, desirably not lower than 400 kHz and not higher than 600 kHz, and more desirably 600 kHz).

If a bias voltage of high frequency (e.g., 13.56 MHz) is applied, then the ion energy becomes low and the ion density becomes high. If, by contrast, a bias voltage of low frequency is applied, then the ion energy becomes high and the ion density becomes low. According to the present invention, by applying a low-frequency bias voltage, even though an inert gas (e.g., argon gas) is not used in the processing gas, the ion energy is high and a satisfactory sputtering effect (etching performance) can be achieved. Furthermore, by using a mixture of a plurality of different fluorochemical gases, it is possible to speed up the etching rate and to improve the resist selectivity.

In the present invention, a particularly desirable mode is one where the etching object is a piezoelectric body (piezoelectric film), as in the embodiment described above. In this case, the beneficial effects described above can be displayed more remarkably.

In the present invention, a desirable mode is one which uses as the processing gas a gas mixture of SF₆ gas and a fluorocarbon gas (and more desirably, a gas mixture of SF₆ gas and C₄F₈ gas). As the fluorocarbon gas, apart from C₄F₈ gas, it is also possible to use a gas such as C₂F₆, C₃F₆, C₃F₈, C₄F₆, C₅F₈, CF₄, or the like. By using SF₆ gas, it is possible to increase the etching rate. Moreover, C₄F₈ gas has an action of forming a protective film on the resist, and is able to raise the resist selectivity. In this way, by using a gas mixture of a plurality of fluorochemical gases as the processing gas, and by applying a low-frequency bias voltage, it is possible to improve the etching performance.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A dry etching method of performing etching, the method comprising the steps of:
supplying a processing gas which is a gas mixture of a plurality of fluorochemical gases; and
generating plasma under a high vacuum while supplying the processing gas and applying a low-frequency bias voltage.

2. The dry etching method as defined in claim 1, wherein the gas mixture is of SF₆ gas and a gas containing fluorine.

3. The dry etching method as defined in claim 2, wherein a mixture ratio of SF₆ gas is not higher than 40%.

4. The dry etching method as defined in claim 2, wherein the gas containing fluorine is C₄F₈.

5. The dry etching method as defined in claim 1, wherein a frequency of the bias voltage is not lower than 200 kHz and not higher than 2 MHz.

6. A dry etching apparatus, comprising:
a vacuum container containing a stage on which a body to be etched is mounted;
a high-frequency power source which generates plasma in the vacuum container;
a processing gas supply device which supplies a processing gas into the vacuum container; and
a bias power source which applies a low-frequency bias voltage to the stage,
wherein the processing gas is a gas mixture of a plurality of fluorochemical gases.
